(19) United States
(12) Patent Application Publication
(10) Pub. No.: US 2002/0112011 A1
(43) Pub. Date: Aug. 15, 2002

(54) Method for anonymously communicating employee comments to an employer

(76) Inventor: Valdemar L. Washington, Flint, MI (US)

Correspondence Address: Douglas W. Sprinkle, Gifford, Krass, Groh, Sprinkle,, Anderson & Citkowski, P.C., 280 N. Old Woodward, Suite 400, Birmingham, MI, 48009, US

(21) Appl. No.: 09/784,462

(22) Filed: Feb. 15, 2001

(51) Int. Cl. G06F 15/16

(52) U.S. Cl. 709/206; 709/246

(57) ABSTRACT

A method is disclosed for anonymously communicating employee comments, such as employee complaints, workplace issues or other concerns, to an employer of that employee. The method includes the step of transmitting the employee comments directly from the employee to a third party wherein the third party is independent from the employer. The third party then removes all employee identifying indicia from the comments to create redacted comments. The third party then transmits these redacted comments directly to the employer. Preferably, the communications between the employee and the third party as well as between the third party and the employer are transmitted over a telecommunications network, such as the world wide web.

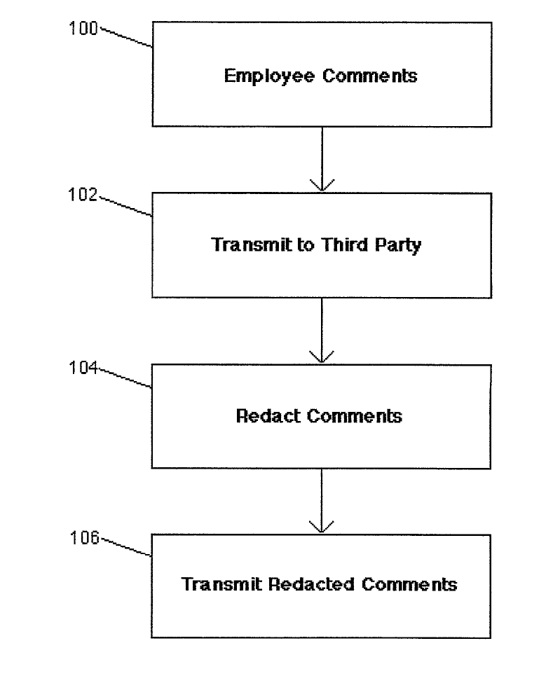

### BACKGROUND OF THE INVENTION

I. Field of the Invention

The present invention relates to a method for anonymously communicating employee comments to the employee's employer.

II. Description of the Prior Art

There are many situations in which an employee desires to communicate with his or her employer regarding complaints, workplace issues or other concerns, suggestions, or the like for the workplace environment. However, many employees are fearful of reprisals or other repercussions from their employer as a result of such employee comments. For that reason, many employees decline to submit employee comments to their employer and, instead, merely keep such employee comments to themselves. This is true even when the employer has a “suggestion box” in the workplace since the employee submitting the suggestion can be seen by the employer.

Employers, on the other hand, oftentimes have no effective means or mechanism for learning of employee comments in the workplace. Furthermore, in many cases, the employer is highly desirous of learning about unacceptable workplace conditions. Furthermore, in some instances, the unacceptable workplace conditions may even result in litigation directed against the employer, for example where the unacceptable workplace conditions include sexual, racial or other forms of illegal discrimination.

Similarly, in many instances the employees are the most knowledgeable regarding unsafe working conditions since it is the employees themselves who work under such unsafe conditions. In these cases, it would be highly beneficial to both the employer and the employee for the employer to learn about such unsafe conditions and correct them.

Likewise, other employee issues and concerns, if known to the employer, may oftentimes be dealt with in a fashion advantageous to both the employee and the employer.

### SUMMARY OF THE PRESENT INVENTION

The present invention provides a method for anonymously communicating employee comments to the employer of the employee which overcomes all of the above-mentioned disadvantages of the previously known situations.

In brief, the method of the present invention comprises the first step of the employee transmitting the employee comments, e.g. employee complaints, issues and/or concerns, directly to a third party. This third party, furthermore, is independent of the employer. Preferably, the employee communicates his or her comments to the third party over a telecommunications network, such as the world wide web.

Upon receipt of the employee comments by the third party, the third party then removes all employee identifying indicia from the employee comments to form redacted comments. Such employee identification indicia would include, for example, the e-mail address of the employee, the employee's name, employee identification number and the like.

After the third party has removed all of the employee identification indicia from the initial comments from the employee, the third party then transmits the redacted comments directly to the employer. Again, the third party preferably transmits the redacted comments over a telecommunications network, such as the world wide web.

Since all employee identifying indicia is removed from the employee comments prior to transmission of the redacted comments by the third party to the employer, the employee can safely raise objections, comments and complaints to the employer without fear of reprisal by the employer. Furthermore, since the communication from the employee to the third party preferably occurs over a telecommunications network, unlike the previously known on-site “suggestion boxes,” the submission of the comment or complaint by the employee to the employer via the third party is accomplished completely anonymously.

### BRIEF DESCRIPTION OF THE DRAWING

A better understanding of the present invention will be had upon reference to the following detailed description, when read in conjunction with the accompanying drawing which is a diagrammatic view illustrating the method of the present invention.

### DETAILED DESCRIPTION OF A PREFERRED EMBODIMENT OF THE PRESENT INVENTION

With reference to the drawing, a preferred embodiment of the present invention is there shown diagrammatically. At step 100, the employee creates the employee's comments. These comments may include employee complaints about workplace safety issues, racial, sexual or other types of discrimination as well as other employee issues and/or concerns (hereinafter collectively referred to as “employee comments”). The employee's comments created at step 100 typically, but not necessarily, would include employee identifying indicia, such as the employee's name, employee number and the like.

The employee's comments are then transmitted to a third party at step 102. Preferably, the employee's comments are transmitted to the third party at step 102 via a telecommunications network, such as the world wide web. As such, the employee can submit his or her comments directly to the third party at step 102 at a location remote from the workplace and, indeed, in the privacy of the employee's own home.

The third party, furthermore, is independent from the employer. By “independent” it is meant that the third party is not an employee of the employer but, rather, operates independently of the employer. It will be understood, of course, that the employer may pay the third party for its services but in no event is the third party obligated to provide the employee comments received directly from the employee to the employer prior to redaction.

At step 104, the third party redacts the employee's comments to remove any and all employee identifying indicia. Such identifying indicia can include, for example, the employee's name, employee number and even the employee e-mail address if the comments are received over a telecommunications network.

After redacting the employee comments, the third party forms the redacted comments at step 104. The third party then transmits the redacted comments to the employer at step 106 so that the employer is advised about safety issues, discrimination issues or other issues in the workplace. Preferably, the third party transmits the redacted comments to the employer over a telecommunications network, such as the world wide web.

Since all employee identifying indicia is removed from the redacted comments prior to transmission of the redacted comments by the third party to the employer, not only is the employer advised as to undesirable conditions in the workplace, or other employee complaints, issues and/or concerns, but the employee is also completely isolated from any possible reprisals or repercussions from the employer that might otherwise be caused if the employee directly made the comments to the employer. This, in turn, is expected to stimulate more candid employee comments than may otherwise be obtained.

Having described my invention, many modifications thereto will become apparent to those skilled in the art to which it pertains without deviation from the spirit of the invention as defined by the scope of the appended claims.

I claim:

1. A method for anonymously communicating employee comments to an employer of the employee comprising the steps of:
transmitting said employee comments from the employee to a third party, said third party being independent from the employer,
said third party removing all employee identifying indicia from the comments to thereby form redacted comments, and
said third party thereafter forwarding said redacted comments to the employer.

2. The method as defined in claim 1 wherein said transmitting step further comprises the step of transmitting said employee comments over a telecommunications network.

3. The method as defined in claim 2 wherein said communications network comprises the world wide web.

4. The method as defined in claim 1 wherein said forwarding step further comprises the step of transmitting said redacted comments over a telecommunications network.

5. The method as defined in claim 4 wherein said communications network comprises the world wide web.

6. The method as defined in claim 1 wherein said identifying indicia comprises an e-mail address.
